(19) United States
(12) Patent Application Publication
(10) Pub. No.: US 2024/0193424 A1
(43) Pub. Date: Jun. 13, 2024

(54) COMPUTER-READABLE RECORDING MEDIUM STORING DISTRIBUTED LEARNING PROGRAM, DISTRIBUTED LEARNING METHOD, AND DISTRIBUTED LEARNING DEVICE

(71) Applicant: Fujitsu Limited, Kawasaki-shi (JP)

(72) Inventor: Akihiro TABUCHI, Kawasaki (JP)

(73) Assignee: Fujitsu Limited, Kawasaki-shi (JP)

(21) Appl. No.: 18/462,531

(22) Filed: Sep. 7, 2023

(30) Foreign Application Priority Data
Dec. 13, 2022 (JP) 2022-198811

(51) Int. Cl. G06N 3/084; G06N 3/045

(52) U.S. Cl. CPC G06N 3/084; G06N 3/045

(57) ABSTRACT

A non-transitory computer-readable recording medium stores a distributed learning program for causing a computer to perform a process including: identifying a layer group that includes at least one layer in which a memory capacity shortage occurs when machine learning of a machine learning model that includes a plurality of layers is performed in parallel by a plurality of nodes that each has a memory; and causing the plurality of nodes to share processing in the identified layer group.

### CROSS-REFERENCE TO RELATED APPLICATION

This application is based upon and claims the benefit of priority of the prior Japanese Patent Application No. 2022-198811, filed on Dec. 13, 2022, the entire contents of which are incorporated herein by reference.

### FIELD

The embodiment discussed herein is related to a distributed learning program, a distributed learning method, and a distributed learning device.

### BACKGROUND

The scale of a neural network model by deep learning has been continuing to increase, and a large memory capacity is to be consumed at a time of calculation. For example, at a time of machine learning of a neural network model, a larger memory capacity is to be consumed than at a time of inference, such as retention of activation of each layer for calculation of a weight gradient, retention of a weight state, and a working memory for calculation.

International Publication Pamphlet No. WO 2021/111490 is disclosed as related art.

### SUMMARY

According to an aspect of the embodiments, a non-transitory computer-readable recording medium stores a distributed learning program for causing a computer to perform a process including: identifying a layer group that includes at least one layer in which a memory capacity shortage occurs when machine learning of a machine learning model that includes a plurality of layers is performed in parallel by a plurality of nodes that each has a memory; and causing the plurality of nodes to share processing in the identified layer group.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram of a distributed learning device;

FIG. 2 is a diagram for explaining the use of a memory at a time of inference;

FIG. 3 is a diagram for explaining the use of a memory at a time of learning;

FIG. 4 is a diagram for explaining data parallel and model parallel;

FIG. 5 is a diagram for explaining activation checkpointing;

FIG. 6 is a diagram for explaining an outline of this embodiment;

FIG. 7 is a diagram for explaining WSP identification;

FIG. 8 is a diagram for explaining activation distribution;

FIG. 9 is a diagram for explaining an example of worksharing;

FIG. 10 is a block diagram illustrating a schematic configuration of a computer that functions as a distributed learning device;

FIG. 11 is a flowchart illustrating an example of a distributed learning process;

FIG. 12 is a flowchart illustrating an example of a selection process;

FIG. 13 is a diagram for explaining the effects of application of this embodiment; and

FIG. 14 is a diagram for explaining the effects of application of this embodiment.

### DESCRIPTION OF EMBODIMENTS

When the memory capacity is insufficient at a time of execution of machine learning, the process of the machine learning is not properly completed. Therefore, machine learning is performed by parallelizing models in a plurality of nodes (hereinafter referred to as “model parallel”). For example, there is a proposed system in which part of a neural network is assigned to each node, a learning result is derived based on input data, and values of parameters included in part of the neural network are each updated in accordance with the learning result.

Further, in a case where the memory capacity becomes insufficient due to retention of the activation and the working memory to be used at a time of machine learning, the memory usage is reduced by a method called activation checkpointing for reducing the held activation.

However, there is a limit to the memory usage that can be reduced by the activation checkpointing, and there are cases where a temporary memory capacity shortage occurs due to the recalculation of the activation and the working memory during the backpropagation process, and machine learning is not properly completed. Furthermore, there is a problem in that parallelization efficiency is low in model parallel, and it is difficult to achieve machine learning efficiency improvement that matches an increase in the number of nodes that perform distributed learning.

As one aspect, an object of the disclosed technology is to make a backpropagation process executable even in a case where the memory capacity is insufficient.

In the description below, an example of an embodiment according to the disclosed technology is explained with reference to the drawings.

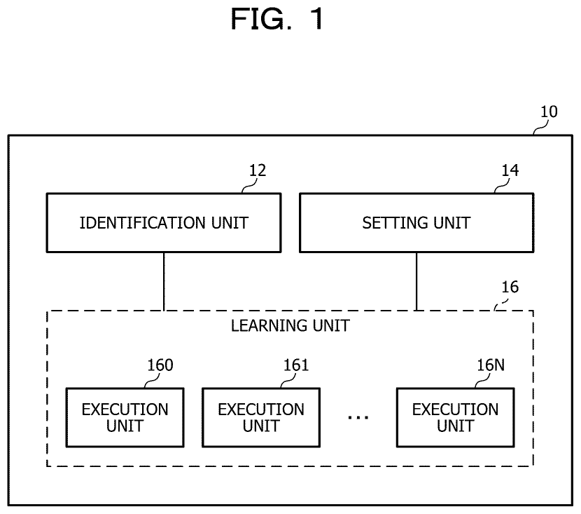

As illustrated in FIG. 1, a distributed learning device 10 according to this embodiment functionally includes an identification unit 12, a setting unit 14, and a learning unit 16.

The learning unit 16 is a functional unit that performs machine learning of a deep neural network model (hereinafter also referred to simply as the “model”) including a plurality of layers. The learning unit 16 includes a plurality of execution units 16n (n=1, 2, . . . , N; N being the number of execution units). Each execution unit 16n is a functional unit formed with each corresponding node of a plurality of nodes that perform distributed learning of the model. The nodes are computers, processors, or the like responsible for one process, and each node has a memory. The learning unit 16 causes the plurality of execution units 16n to perform machine learning of the model in parallel. For example, machine learning of the model is performed in parallel by the plurality of nodes. In this embodiment, in a portion where a memory capacity shortage that will be described later does not occur, distributed learning of the model is performed with data parallel by the plurality of nodes.

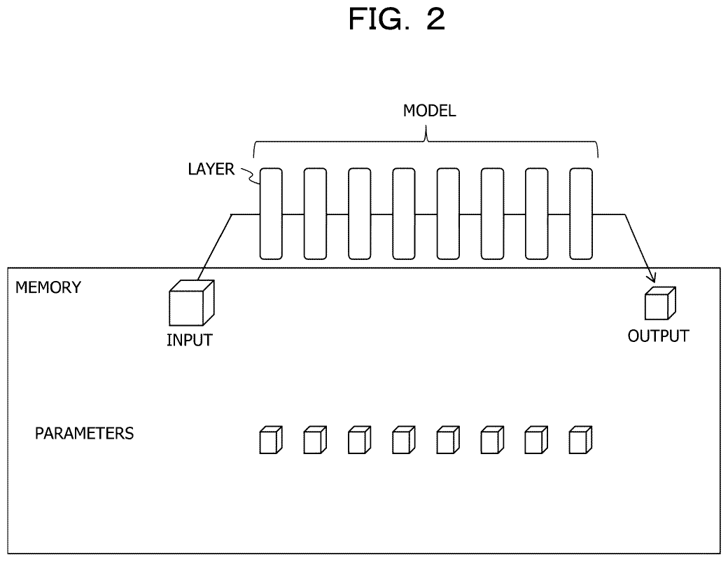

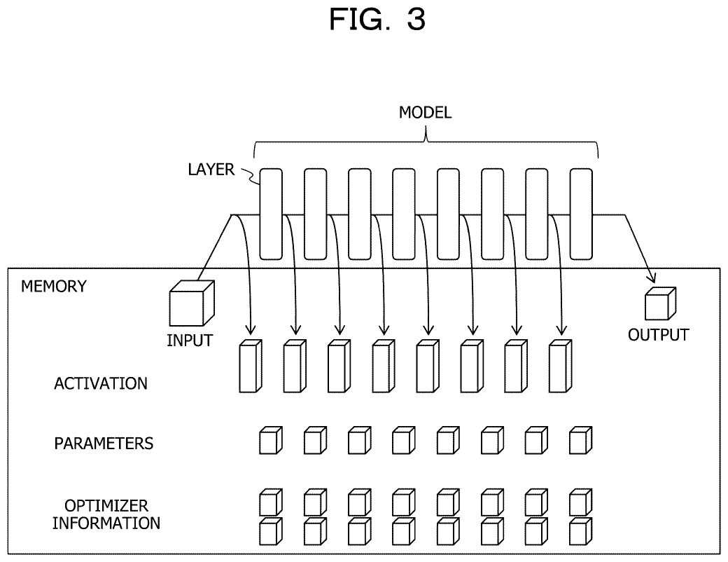

Here, at the time of an inference process using a machine-learned model, the respective pieces of data of an input, parameters, and an output are held in the memory, as illustrated in FIG. 2. The parameters are the weights or the like for the respective layers constituting the model. Meanwhile, at a time of machine learning of the model, in addition to the respective pieces of data of the input, the parameters, and the output, a larger amount of data such as information about the optimizer to be used in an optimization process like activation, momentum, and the like to be used at the time of a backpropagation process is held in the memory than at the time of inference, as illustrated in FIG. 3. Therefore, a memory capacity shortage is likely to occur, for example, at the time of a backpropagation process.

There are the following methods to counter a memory capacity shortage. For example, in a case where the memory capacity is insufficient due to parameters, optimizer information, and the like, there is a method for distributing parameters, optimizer information, and the like to a plurality of nodes, such as data parallel or pipeline parallel. Further, in a case where the memory capacity is insufficient due to activation, there is a method for distributing the held activation to a plurality of nodes, such as activation checkpointing for reducing the held activation, tensor parallel, or pipeline parallel.

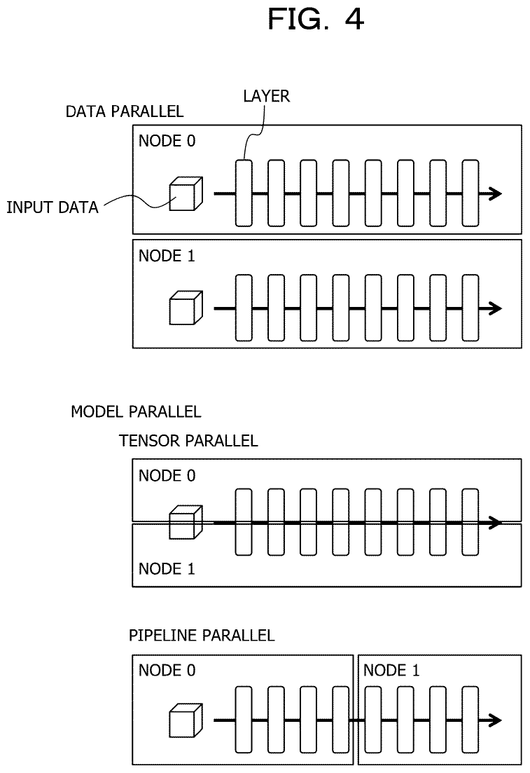

As illustrated in FIG. 4, data parallel is a method for dividing input data by a plurality of nodes (a node 0 and a node 1 in the example in FIG. 4), and performing machine learning of a model in parallel. Tensor parallel and pipeline parallel are examples of model parallel by which a model is distributed to a plurality of nodes, and machine learning is performed in parallel. Tensor parallel is a method by which each layer is divided and distributed to a plurality of nodes, and pipeline parallel is a method by which a model is divided between layers and is distributed to a plurality of nodes.

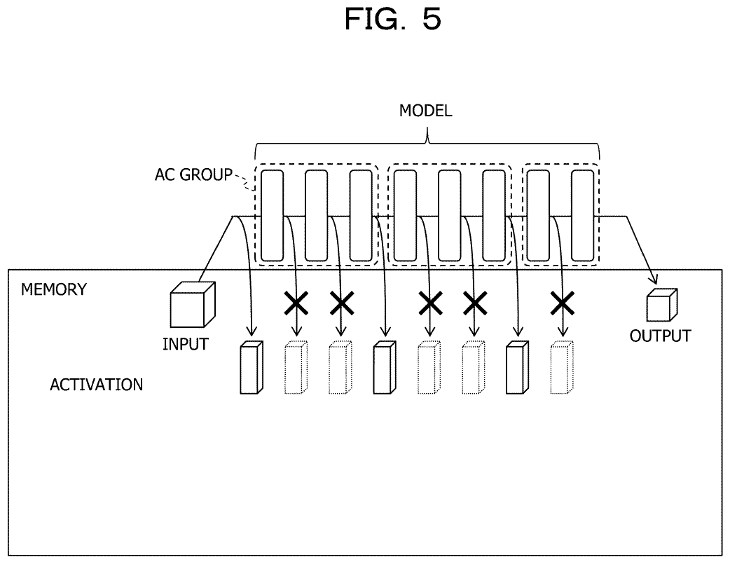

Further, as illustrated in FIG. 5, in the activation checkpointing, groups of layers on which the activation checkpointing is performed are set (the portions indicated by dashed lines in FIG. 5, hereinafter referred to as “AC groups”). Only the inputs to the head layers of the AC groups are then held as the points to be checked, so that the memory usage is reduced. The activation that is not held (the activation indicated by dotted lines in FIG. 5) are recalculated at the time of backpropagation, from the activation held as the points to be checked.

However, there is a limit to the memory usage that can be reduced by the activation checkpointing. For example, when the number of layers included in the model is n, the data amount of the activation in each layer is s, and the number of layers in an AC group is c, the maximum amount of the activation is (ns/c+cs). Here, ns/c represents the amount of data held in the memory at the end of forward propagation, and cs represents the amount of data that increases with recalculation. The minimum amount of the activation is 2s√n where c=√n, and a great memory usage reduction effect is not to be expected.

Furthermore, when model parallel is adopted, the memory usage is greatly reduced, but there is a problem in that the calculation efficiency in machine learning becomes lower. Where the number of microbatches per mini-batch is represented by n_μb, and the number of nodes is represented by n_p, parallelization efficiency by pipeline parallel is (n_μb)/(n_μb+n_p−1). Therefore, the efficiency deteriorates as the number of distributed nodes increases and as the number of microbatches decreases. Since increasing the number of batches leads to an increase in the overall batch size, an increase in the number of batches is preferably avoided as much as possible in distributed learning. Because of this, it is difficult to increase efficiency by pipeline parallel. Meanwhile, in tensor parallel, communication between layers is to be performed in a forward propagation process and a backpropagation process in each layer. Therefore, the overhead is large, and the calculation efficiency is low.

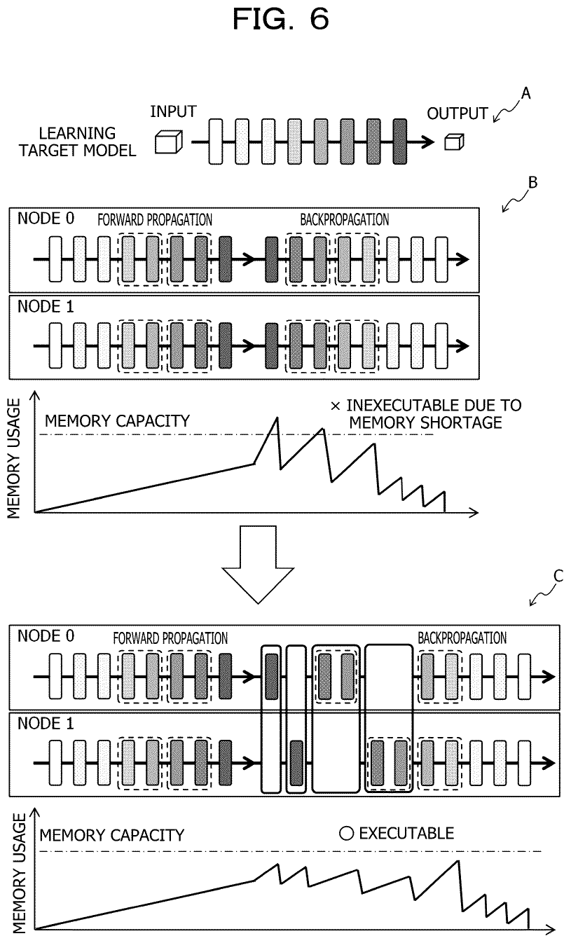

Therefore, in this embodiment, as illustrated in FIG. 6, the identification unit 12 identifies a location where it is not possible to perform a backpropagation process due to a memory capacity shortage, and the setting unit 14 causes a plurality of nodes to share the processing at the identified location. Thus, a memory capacity shortage is avoided, and the backpropagation process is enabled. Note that A in FIG. 6 is the learning target model, B in FIG. 6 is a diagram illustrating a state in which a memory capacity shortage occurs, and C in FIG. 6 is a diagram illustrating a state in which the memory capacity shortage is resolved by sharing processing. In B and C in FIG. 6, for the respective layers in the model, the layer closest to the input side has the lightest shading with halftone dots, and the layer closest to the output side has the darkest shading with halftone dots, so that the respective layers are distinguished from each other. Further, in each of B and C in FIG. 6, the upper diagram illustrates the processing order of the layers in each node (in the example in FIG. 6, the node 0 and the node 1). The graph in the lower half indicates the memory usage corresponding to the processing order of the layers illustrated in the upper half, and the dot-and-dash line indicates the memory capacity. The same applies in the drawings to be described below.

In the description below, each of the identification unit 12 and the setting unit 14 is explained in detail.

The identification unit 12 identifies a layer group including one or more layers in which a memory capacity shortage occurs at the time of a backpropagation process in a case where machine learning of a machine learning model including a plurality of layers is performed in parallel by a plurality of nodes each having a memory. For example, the identification unit 12 identifies a layer in which a backpropagation process becomes inexecutable due to a memory capacity shortage, or an AC group to which the layer belongs. Hereinafter, the layer or the AC group to be identified by the identification unit 12 will be referred to as the portion in which worksharing is performed by a plurality of nodes, which will be abbreviated as “WSP”.

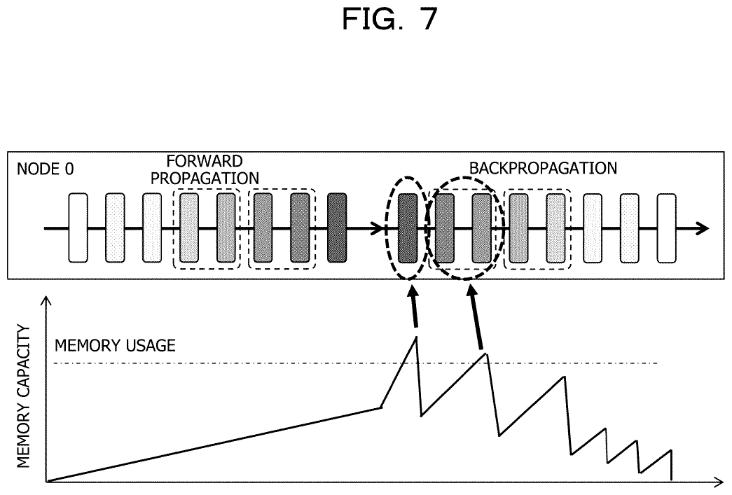

For example, as illustrated in FIG. 7, the identification unit 12 causes the learning unit 16 to perform one step of machine learning of the model, and identifies the WSP corresponding to the location where execution of the machine learning has become an error due to a memory capacity shortage during a backpropagation process. In the graph in the lower half of FIG. 7, the locations where the memory usage exceeds the memory capacity indicates the locations in which execution of machine learning becomes an error due to a memory capacity shortage, and the portions indicated by dashed ellipses in the diagram in the upper half of FIG. 7 is the WSPs corresponding to the locations. For example, when the machine learning is stopped due to an error, the identification unit 12 identifies the WSPs, based on the activation of which layers is held in the memory or the like. When the setting unit 14 sets a worksharing method (which will be described later in detail) for the identified WSPs, the identification unit 12 again causes the learning unit 16 to perform one step of the machine learning of the model, to identify the remaining WSP.

Further, the identification unit 12 may cause the learning unit 16 to perform one step of machine learning in advance in an environment where the memory capacity is larger than the memory capacity of the node of the actual machine that actually performs the machine learning, which is, for example, an environment where the memory capacity is very large. The identification unit 12 may acquire the profile of the memory usage at that time. In this case, the identification unit 12 may identify the location(s) where the memory usage exceeds the memory capacity of the node of the actual machine, based on the acquired profile. Also, the identification unit 12 may identify a WSP by acquiring information about the WSP designated by the user.

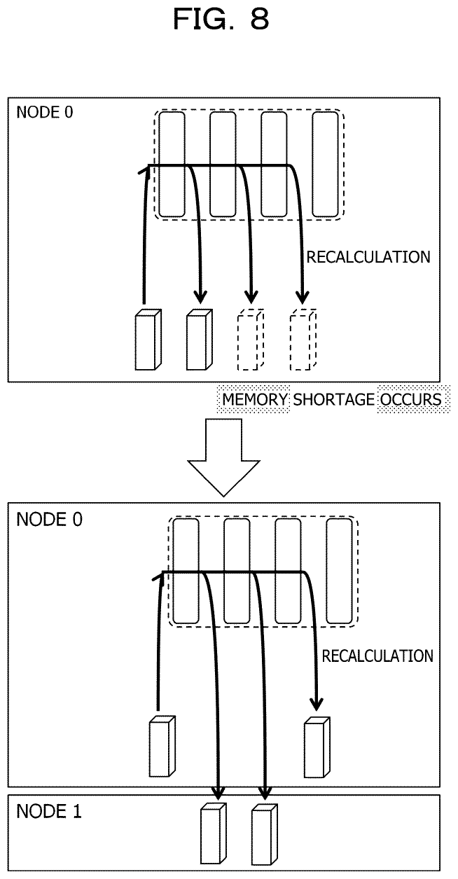

The setting unit 14 selects a worksharing method for causing a plurality of nodes to share processing, for each WSP identified by the identification unit 12. For example, the setting unit 14 selects tensor parallel or activation distribution as the type of worksharing, and selects the number of nodes to perform worksharing. As described above with reference to FIG. 4, tensor parallel is a method for dividing the tensor of a model and distributing the divided tensor to each node. As illustrated in FIG. 8, activation distribution is a method by which, when a memory capacity shortage occurs in recalculation of the activation in a certain node, the activation recalculated by the node is held in the memory of another node. FIG. 8 illustrates an example in which the activation recalculated by the node 0 is held in the memory of the node 1.

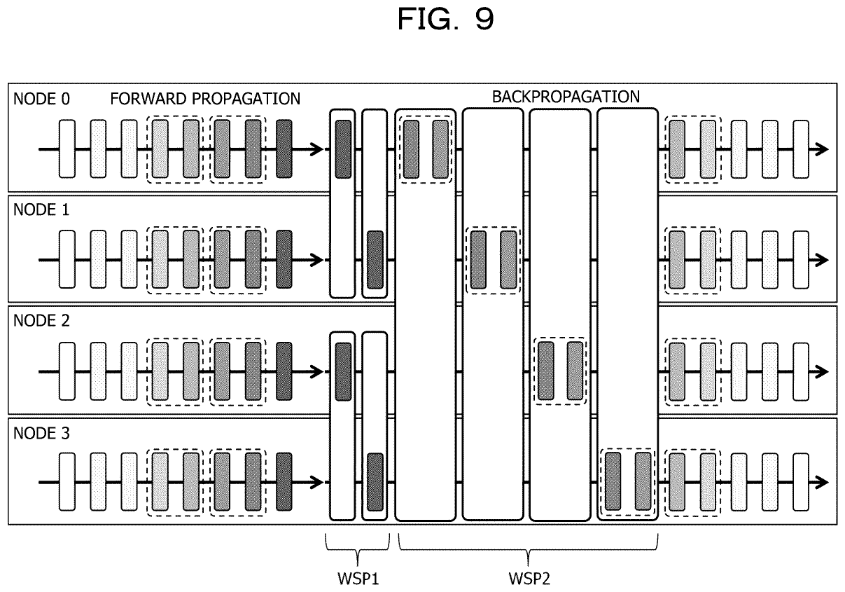

Further, the setting unit 14 selects the number of nodes for performing worksharing so that the number of nodes included in the group of nodes for performing worksharing is a divisor of the total number of nodes, so as not to have any unnecessary node. FIG. 9 illustrates an example of setting of worksharing. In the example on FIG. 9, the total number of nodes is four. For a WSP 1, two nodes form one set, and worksharing is performed by two sets. For a WSP 2, worksharing is performed by four nodes. In this manner, the number of nodes that perform worksharing may differ for each WSP.

The setting unit 14 enumerates combinations of options of worksharing methods and options of the numbers of nodes for performing worksharing as possible worksharing methods. Note that the setting unit 14 may narrow down the possible worksharing methods, based on the cause of a memory capacity shortage, whether the WSP is one layer or an AC group, or the like. For example, in a case where the WSP is one layer, and a memory capacity shortage is caused by an enormous memory capacity for the processing in the layer, the worksharing methods may be narrowed down to a possible worksharing method that is tensor parallel. Meanwhile, in a case where a memory capacity shortage is caused by an enormous amount of activation to be recalculated by the activation checkpointing, the worksharing methods may be narrowed down to a possible worksharing method that is activation distribution.

The setting unit 14 then selects, as the worksharing method, a possible worksharing method that does not cause a memory capacity shortage and has the shortest processing time in a case where a backpropagation process is performed by applying each possible worksharing method to WSPs. The setting unit 14 sets the selected worksharing method for each WSP in each node (each execution unit 16n). As a result, when the learning unit 16 causes the execution units 16n to perform machine learning of the model, the respective set nodes in the WSPs share and sequentially perform the processing of the layers in the WSPs, to realize worksharing.

Note that, in a case where the user designates the WSPs and the worksharing method for each WSP, the setting unit 14 may set the worksharing method for each WSP in each node (each execution unit 16n) in accordance with the designation.

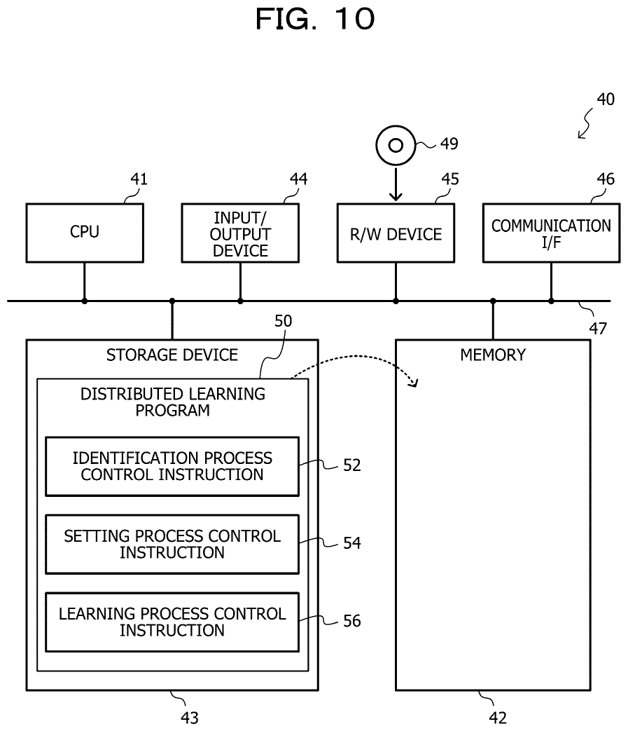

The distributed learning device 10 may be formed with a computer 40 illustrated in FIG. 10, for example. The computer 40 includes a central processing unit (CPU) 41, a memory 42 as a temporary storage area, and a nonvolatile storage device 43. the computer 40 also includes an input/output device 44 such as an input device or a display device, and a read/write (R/W) device 45 that controls reading and writing of data from/into a storage medium 49. The computer 40 also includes a communication interface (I/F) 46 that is connected to a network such as the Internet. The CPU 41, the memory 42, the storage device 43, the input/output device 44, the R/W device 45, and the communication I/F 46 are coupled to one another via a bus 47.

The storage device 43 is, for example, a hard disk drive (HDD), a solid state drive (SSD), a flash memory, or the like. The storage device 43 as a storage medium stores a distributed learning program 50 for causing the computer 40 to function as the distributed learning device 10. The distributed learning program 50 includes an identification process control instruction 52, a setting process control instruction 54, and a learning process control instruction 56.

The CPU 41 reads the distributed learning program 50 from the storage device 43, expands the distributed learning program 50 in the memory 42, and sequentially executes the control instructions included in the distributed learning program 50. The CPU 41 executes the identification process control instruction 52, to operate as the identification unit 12 illustrated in FIG. 1. Also, the CPU 41 executes the setting process control instruction 54, to operate as the setting unit 14 illustrated in FIG. 1. Further, the CPU 41 executes the learning process control instruction 56, to operate as the learning unit 16 illustrated in FIG. 1. With this configuration, the computer 40 that has executed the distributed learning program 50 functions as the distributed learning device 10. Note that the CPU 41 that executes the program is hardware.

Note that the functions implemented by the distributed learning program 50 may be implemented by, for example, a semiconductor integrated circuit, or for example, an application specific integrated circuit (ASIC), a field-programmable gate array (FPGA), or the like, for example.

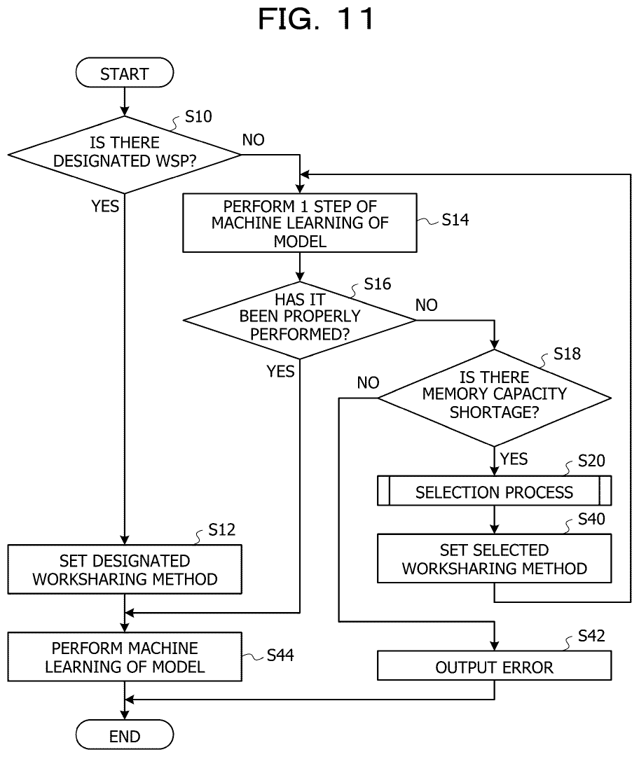

Next, an operation of the distributed learning device 10 according to this embodiment is described. When machine learning of a model is instructed in the distributed learning device 10, the distributed learning device 10 performs a distributed learning process illustrated in FIG. 11. Note that the distributed learning process is an example of a distributed learning method according to the disclosed technology.

In step S10, the setting unit 14 determines whether WSPs and worksharing methods for the respective WSPs are designated by the user. If the designations have been made, the operation moves on to step S12. If the designations are not made, the operation moves on to step S14.

In step S12, the setting unit 14 acquires the user-designated WSPs and information about the worksharing methods for the respective WSPs written in a text file or the like, for example, and sets the worksharing methods for the respective WSPs in the respective nodes, based on the acquired information. The operation then moves on to step S44.

In step S14, the learning unit 16 performs one step of machine learning of the model. Next, in step S16, the identification unit 12 determines whether the machine learning has been properly performed. If the machine learning has been properly performed, the operation moves on to step S44. If an error occurs, the operation moves on to step S18. In step S18, the identification unit 12 determines whether the cause of the error is the occurrence of a memory capacity shortage during the backpropagation process. If the cause of the error is a memory capacity shortage, the operation moves on to step S20. If the cause is not a memory capacity shortage, the operation moves on to step S42. In step S42, the identification unit 12 outputs the cause of the error, and the distributed learning process comes to an end.

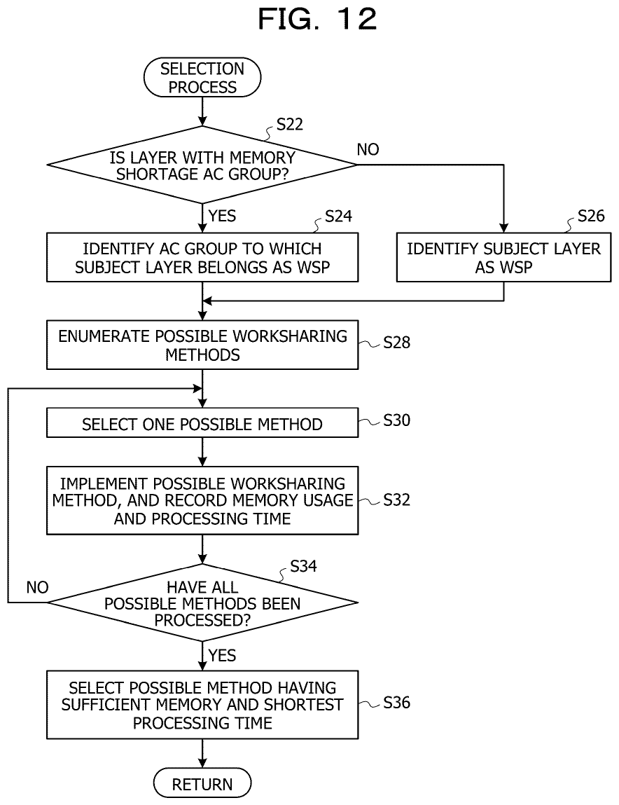

In step S20, a selection process is performed. Here, the selection process is described with reference to FIG. 12.

In step S22, the identification unit 12 determines whether the layer having a memory capacity shortage is a layer belonging to a group of layers, for example an AC group, for which activation checkpointing is to be performed. If the layer belongs to an AC group, the operation moves on to step S24. If the layer does not belong to an AC group, the operation moves on to step S26. In step S24, the identification unit 12 identifies the AC group to which the layer having the memory capacity shortage belongs as a WSP. In step S26, on the other hand, the identification unit 12 identifies the layer having the memory capacity shortage as a WSP.

Next, in step S28, the setting unit 14 enumerates combinations of options of worksharing methods and options of the numbers of nodes for performing worksharing as possible worksharing methods. Next, in step S30, the setting unit 14 selects one from among the enumerated possible combinations. Next, in step S32, the setting unit 14 applies the worksharing method indicated by the selected possible combination to the WSP identified in step S24 or S26 described above, performs a backpropagation process, and records the memory usage and the processing time.

Next, in step S34, the setting unit 14 determines whether the above process in step S32 has been completed for all the possible combinations. If there exists an unprocessed possible combination, the operation returns to step S30. If the processing of all the possible combinations has been completed, the operation moves on to step S36. In step S36, the setting unit 14 selects, as the worksharing method, the possible combination having a sufficient memory capacity and the shortest processing time, and returns to the distributed learning process (FIG. 11).

Next, in step S40, the setting unit 14 sets the WSP identified by the identification unit 12 and the worksharing method selected for the WSP in each node (each execution unit 16n), and the operation returns to step S14. After all the locations each having a memory capacity shortage in the model are identified as WSPs, and the worksharing methods are set, the result of determination in step S16 becomes affirmative, and the operation moves on to step S44. In step S44, the learning unit 16 causes the execution units 16n to perform machine learning of the model, and the distributed learning process comes to an end.

Note that, in a case where WSPs are identified from the profile of the memory usage acquired by performing machine learning of the model in an environment where the memory capacity is very large, the selection process in step S20 (FIG. 12) may be performed for each location where the memory usage exceeds the memory capacity of the actual machine.

As described above, the distributed learning device according to this embodiment performs machine learning of a machine learning model including a plurality of layers in parallel at a plurality of nodes each having a memory. At the time of the backpropagation process during the machine learning, the distributed learning device identifies a layer group including one or more layers having a memory capacity shortage, and causes a plurality of nodes to share and perform the processing in the specified layer group. Thus, even in a case where the memory capacity is insufficient, the backpropagation process can be made executable.

Also, the distributed learning device according to this embodiment performs machine learning of the model independently in each node by data parallel in a portion where the memory capacity of the node is not insufficient, and performs worksharing in a plurality of nodes in a portion where the memory capacity is temporarily insufficient at the time of backpropagation. Thus, it is possible to perform machine learning with high efficiency, while avoiding a memory capacity shortage.

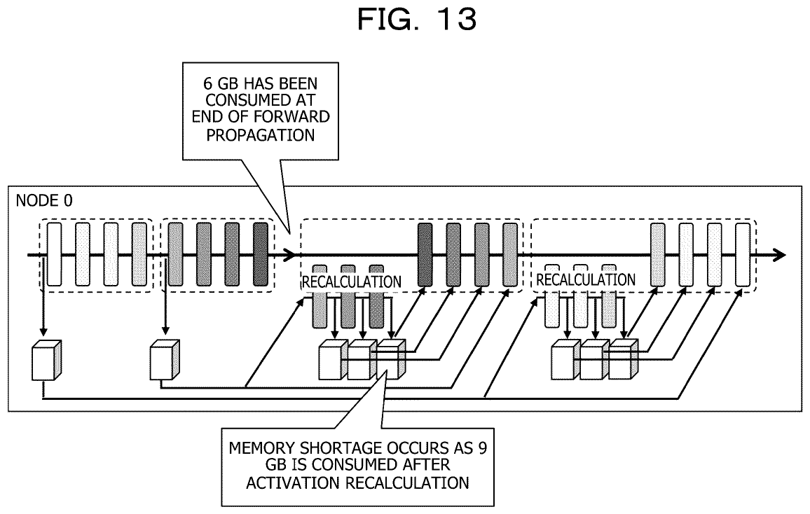

The effects of application of this embodiment are described through a specific example. For example, it is assumed that the memory capacity of each node is 8 gigabytes (GB), and the size of each activation is 1 GB. As illustrated in FIG. 13, it is assumed that 6 GB of memory capacity has been consumed at the end of the forward propagation in the node 0, 9 GB is consumed after activation recalculation, and a memory capacity shortage occurs.

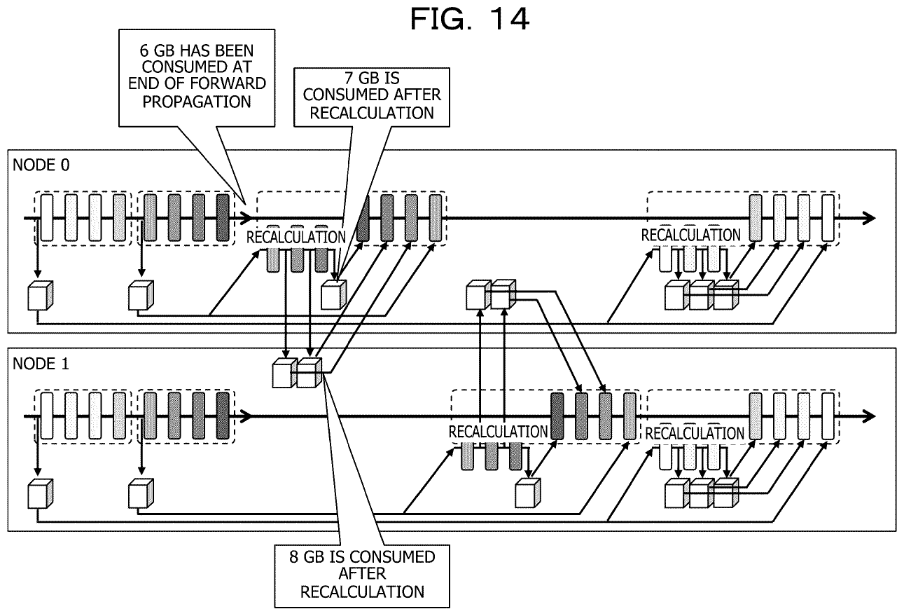

As illustrated in FIG. 14, this embodiment is applied, the AC group in the first half of the backpropagation in which a memory capacity shortage occurs is identified as a WSP, and activation distribution is applied as the worksharing method. In this case, the memory of the node 1 is made to hold 2 GB of the 3 GB for activation recalculated in the node 0. As a result, 7 GB of the memory capacity is consumed after the recalculation in the node 0, and a memory capacity shortage can be avoided. On the other hand, when the WSP portion is recalculated in the node 1, 8 GB of the memory capacity of the node 1 is consumed. The memory of the node 0 is made to hold 2 GB of the 3 GB for activation recalculated in the node 1, so that a memory capacity shortage of the node 1 is avoided. Further, at this point of time, the recalculated activation held in the node 0 has been deleted at the end of the process, and 6 GB of the memory capacity has been consumed. Thus, the 2 GB for activation recalculated in the node 1 can be held. As described above, by causing the memory of another node to hold the activation recalculated in one node, it is possible to avoid a memory capacity shortage.

Furthermore, while the distributed learning program is stored (installed) beforehand in the storage device in the embodiment described above, the embodiment is not limited to this. The program according to the disclosed technology may be provided in a form stored in a storage medium such as a compact disc read only memory (CD-ROM), a digital versatile disc read only memory (DVD-ROM), or a universal serial bus (USB) memory.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a distributed learning program for causing a computer to perform a process comprising:
identifying a layer group that includes at least one layer in which a memory capacity shortage occurs when machine learning of a machine learning model that includes a plurality of layers is performed in parallel by a plurality of nodes that each has a memory; and
causing the plurality of nodes to share processing in the identified layer group.

2. The non-transitory computer-readable recording medium according to claim 1, wherein the identifying the layer group is performed during a backpropagation process in the machine learning.

3. The non-transitory computer-readable recording medium according to claim 2, wherein the identifying the layer group includes identifying a location at which execution of machine learning becomes an error due to a memory capacity shortage during the backpropagation process.

4. The non-transitory computer-readable recording medium according to claim 2, wherein the identifying the layer group includes acquiring a profile of memory usage when the machine learning is performed in an environment with a larger memory capacity than the plurality of nodes, and based on the profile, identifying a location at which the memory usage exceeds a memory capacity of the plurality of nodes that are actual machines.

5. The non-transitory computer-readable recording medium according to claim 1, wherein, when the layer group is a group of layers for which activation checkpointing is performed, the causing the plurality of nodes to share the processing in the layer group includes causing a memory of a second node to hold an activation recalculated in a first node.

6. The non-transitory computer-readable recording medium according to claim 1, wherein the causing the plurality of nodes to share the processing in the layer group includes causing two or more nodes among the plurality of nodes to perform the processing in the layer group by tensor parallel.

7. The non-transitory computer-readable recording medium according to claim 2, wherein, as a method for causing the plurality of nodes to share the processing in the layer group, a possible combination that has a sufficient memory capacity and the shortest processing time is selected when the backpropagation process is performed for each possible combination of the number of nodes in the plurality of nodes and a selectable method.

8. The non-transitory computer-readable recording medium according to claim 7, wherein the possible combinations are narrowed down based on at least one of a cause of occurrence of a memory capacity shortage and the number of layers included in the layer group.

9. The non-transitory computer-readable recording medium according to claim 1, wherein, at a portion in which the memory capacity is not insufficient, machine learning is performed in parallel by the plurality of nodes.

10. A distributed learning method comprising:
identifying a layer group that includes at least one layer in which a memory capacity shortage occurs when machine learning of a machine learning model that includes a plurality of layers is performed in parallel by a plurality of nodes that each has a memory; and
causing the plurality of nodes to share processing in the identified layer group.

11. The distributed learning method according to claim 10, wherein the identifying the layer group is performed during a backpropagation process in the machine learning.

12. The distributed learning method according to claim 11, wherein the identifying the layer group includes identifying a location at which execution of machine learning becomes an error due to a memory capacity shortage during the backpropagation process.

13. The distributed learning method according to claim 11, wherein the identifying the layer group includes acquiring a profile of memory usage when the machine learning is performed in an environment with a larger memory capacity than the plurality of nodes, and based on the profile, identifying a location at which the memory usage exceeds a memory capacity of the plurality of nodes that are actual machines.

14. The distributed learning method according to claim 10, wherein, when the layer group is a group of layers for which activation checkpointing is performed, the causing the plurality of nodes to share the processing in the layer group includes causing a memory of a second node to hold an activation recalculated in a first node.

15. The distributed learning method according to claim 10, wherein the causing the plurality of nodes to share the processing in the layer group includes causing two or more nodes among the plurality of nodes to perform the processing in the layer group by tensor parallel.

16. The distributed learning method according to claim 11, wherein, as a method for causing the plurality of nodes to share the processing in the layer group, a possible combination that has a sufficient memory capacity and the shortest processing time is selected when the backpropagation process is performed for each possible combination of the number of nodes in the plurality of nodes and a selectable method.

17. The distributed learning method according to claim 7, wherein the possible combinations are narrowed down based on at least one of a cause of occurrence of a memory capacity shortage and the number of layers included in the layer group.

18. The distributed learning method according to claim 10, wherein, at a portion in which the memory capacity is not insufficient, machine learning is performed in parallel by the plurality of nodes.

19. A distributed learning device comprising:
a memory; and
a processor coupled to the memory and configured to:
identify a layer group that includes at least one layer in which a memory capacity shortage occurs when machine learning of a machine learning model that includes a plurality of layers is performed in parallel by a plurality of nodes that each has a memory; and
cause the plurality of nodes to share processing in the identified layer group.

20. The distributed learning device according to claim 19, wherein the processor identifies the layer group during a backpropagation process in the machine learning.
